(19) United States
(12) Patent Application Publication
(10) Pub. No.: US 2003/0103087 A1
(43) Pub. Date: Jun. 5, 2003

(54) Electronic apparatus having two position input unit

(76) Inventor: Tetsuo Hatakeyama, Tachikawa-shi (JP)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(21) Appl. No.: 10/262,078

(22) Filed: Oct. 2, 2002

(30) Foreign Application Priority Data
Nov. 30, 2001 (JP) 2001-367851

(51) Int. Cl. G09G 5/00

(52) U.S. Cl. 345/815; 345/788

(57) ABSTRACT

An electronic apparatus comprises a display unit having a display screen, and an input unit for inputting information. The input unit includes a first input operation section and a second input operation section. The second input operation section is located opposite to the first input operation section, and is larger than the first input operation section. The input unit is selectable between a first position in which the first input operation section can be operated while viewing the display screen, and a second position in which the second input operation section can be operated while viewing the display screen.

### CROSS-REFERENCE TO RELATED APPLICATIONS

This application is based upon and claims the benefit of priority from the prior Japanese Patent Application No. 2001-367851, filed Nov. 30, 2001, the entire contents of which are incorporated by reference.

### BACKGROUND OF THE INVENTION

1. Field of the Invention

The present invention relates to an electronic apparatus such as a portable information tool having an input unit that can be used in two positions.

2. Description of the Related Art

Portable information tools are now popular which have, for example, schedule management, address book, memo and mail functions. Such portable information tools are thin and compact, to enhance portability.

Japanese Patent Application KOKAI Publication No. 7-168667, for example, discloses a conventional portable information tool. This tool comprises a main unit having a display screen, a lid having a plurality of keys for an input operation, and a tablet unit for an input operation using a pen. The lid and tablet unit are rotatably supported by the main unit, using a hinge mechanism.

When the portable information tool is used one hand is used to hold the main unit and the other is used to operate the keys of the lid. To input information using the tablet unit, the tablet unit is superposed upon the main unit or the lid, and the user inputs information with a pen held in the other hand.

In portable information tools whose portability is regarded as important, the size of the main unit or lid is being more and more reduced. As a result, in particular, in the lid, the keys are made compact and arranged densely in a small area. Therefore, when a user uses a portable information tool, increasing the chance of input errors.

### BRIEF SUMMARY OF THE INVENTION

It is an embodiment of the invention to provide an easy-to-use electronic apparatus with an input unit of high operability.

An electronic apparatus according to an embodiment of the invention comprises a display unit having a display screen, and an input unit for inputting information. The input unit includes a first input operation section and a second input operation section. The second input operation section is located opposite to the first input operation section, and is larger than the first input operation section. The input unit is selectable between a first position in which the first input operation section can be operated while viewing the display screen, and a second position in which the second input operation section can be operated while viewing the display screen.

By virtue of this structure, one of the first and second input operation sections can be selected when a user uses the apparatus by holding it in one hand, and when they use it, placed on, for example, a desk. Thus, the user can operate the apparatus optimally in different states of use.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a PDA (Personal Digital Assistant) according to a first embodiment of the invention, showing a state in which an input unit is rotated to a first position;

FIG. 2 is a perspective view of the PDA of the first embodiment, showing a state in which the input unit is rotated to a second position;

FIG. 3 is a perspective view of the PDA of the first embodiment, showing a state in which the input unit is in a position halfway between the first position and the second position;

FIG. 4 is a sectional view illustrating a hinge mechanism employed in the first embodiment;

FIG. 5 is a block diagram illustrating the control system for a display unit and the input unit employed in the first embodiment;

FIG. 6 is a flowchart useful in explaining the control executed to reverse the input unit into the first or second position;

FIG. 7 is a perspective view illustrating a PDA according to a second embodiment of the invention;

FIG. 8 is a perspective view of the PDA of the second embodiment, showing a state in which a tablet is superposed upon a display screen; and

FIG. 9 is a perspective view of the PDA of the second embodiment, showing a state in which the tablet is superposed upon a second keyboard.

### DETAILED DESCRIPTION OF THE INVENTION

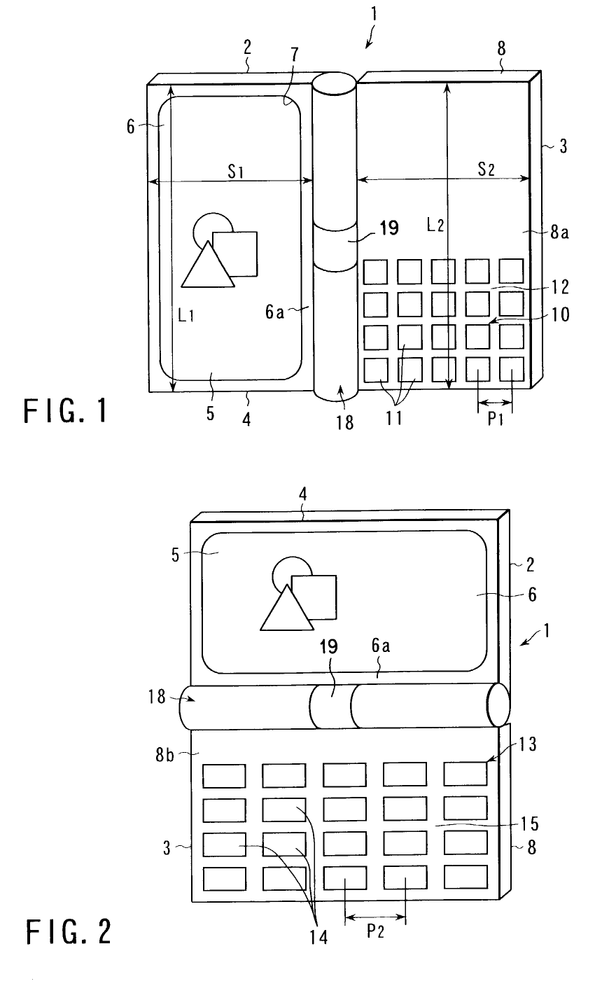

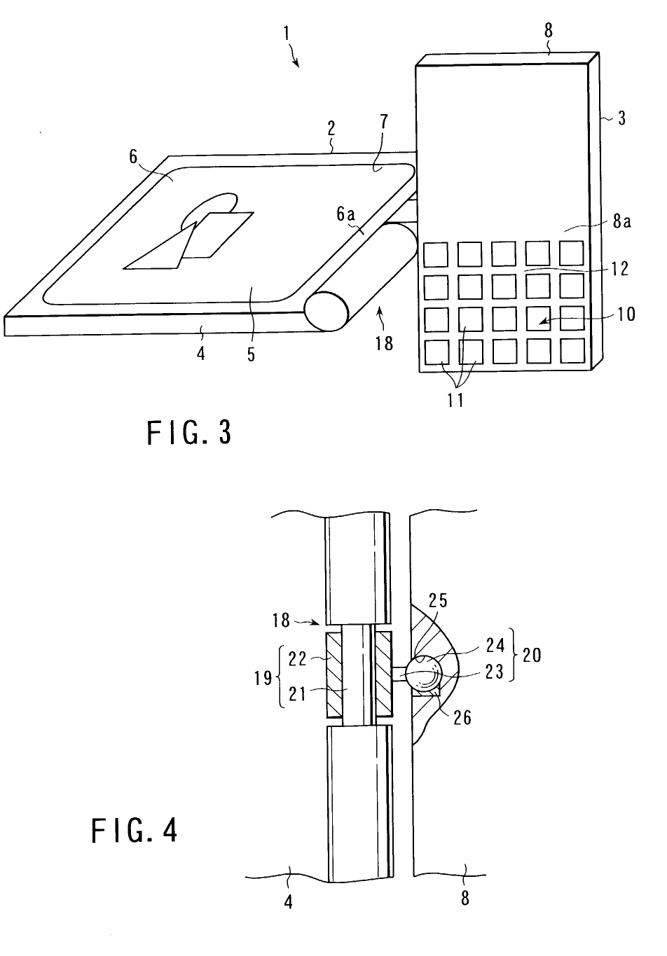

Referring first to FIGS. 1-6, a first embodiment of the invention will be described.

FIGS. 1-3 show a PDA (Personal Digital Assistant) 1 as an electronic apparatus. The PDA 1 comprises a display unit 2 and input unit 3. The display unit 2 has a display housing 4 and liquid crystal display 5 housed therein. The display housing 4 is a rectangular flat box having a length L1 and width S1. The liquid crystal display 5 has a display screen 6 for displaying image information. The display screen 6 is exposed to the outside of the display unit 2 through a display window 7 that opens at the front surface of the display housing 4.

The input unit 3 has a keyboard housing 8. The keyboard housing 8 is a rectangular flat box having a length L2 and width S2, and has substantially the same size as the display housing 4. A first keyboard 10 is provided on the first surface 8a of the keyboard housing 8, and serves as a first input operation section. The first keyboard 10 has a plurality of keys 11. The keys 11 are arranged on a first area 12 of the first surface 8a. When the input unit 3 assumes a portrait position, the first area 12 occupies the lower half of the first surface 8a. Accordingly, a user can easily operate the keys 11 by the fingers when the input unit 3 assumes the portrait position.

The keyboard housing 8 has a second surface 8b located opposite to the first surface 8a. A second keyboard 13 is provided on the second surface 8b, and serves as a second input operation section. The second keyboard 13 has a plurality of keys 14. The keys 14 are arranged on a second area 15 that occupies the entire second surface 8b and is substantially twice the size of the first area 12. Accordingly, a user can easily operate the keys 14 when the input unit 3 assumes a landscape position.

More specifically, the keys 14 of the second keyboard 13 are larger than the keys 11 of the first keyboard 10, and are arranged with a wider pitch P2 than that of the keys 11 (P1). In other words, the size and arrangement of the keys 14 of the second keyboard 13 are adjusted so that a user can easily operate the keys with both hands.

Further, although the keys 11 and 14 have different sizes and arrangements, they have the same input functions. Accordingly, input information is displayed on the display screen 6 irrespective of whether the input operation is executed using the first keyboard 10 or second keyboard 13.

As shown in FIGS. 1-4, a hinge mechanism 18 connects the display unit 2 to the input unit 3. The hinge mechanism 18 is interposed between the display housing 4 and keyboard housing 8, and includes first and second pivot sections 19 and 20.

As shown in FIG. 4, the first pivot section 19 is supported by the display housing 4. The first pivot section 19 has a hinge shaft 21 and sleeve 22. The hinge shaft 21 extends along the long side 6a (of the length L1) of the display housing 4, and is fixed to the middle portion of the long side 6a. The sleeve 22 is fitted on the periphery of the hinge shaft 21 so that it can pivot about the shaft.

The second pivot section 20 has a support shaft 23 and ball 24. The support shaft 23 extends along the width S1 of the display housing 4, and projects to the keyboard housing 8. Thus, the hinge shaft 21 and support shaft 23 are perpendicular to each other. The ball 24 is fixed to the end of the support shaft 23 remote from the hinge shaft 21, and is rotatably fitted in a spherical bearing 25 provided in the keyboard housing 8. As a result, the input unit 3 can also rotate about the support shaft 23.

With this structure, the input unit 3 can pivot on the hinge shaft 21 of the first pivot section 19 between a closed position in which it covers the display screen 6 of the display unit 2, and an open position in which the display screen 6 is exposed. Furthermore, the input unit 3 can rotate about the ball 24 of the second pivot section 20 through 1800 between a first position in which the first keyboard 10 is aligned with the display screen 6, and a second position in which the second keyboard 13 is aligned with the display screen 6.

FIG. 1 shows a first state of use in which the input unit 3 is in the first position and is open. In the first state of use, the user faces the display screen 6 and first keyboard 10 and can operate the first keyboard 10 while viewing the display screen 6. Further, in this state, the display screen 6 and first keyboard 10 are arranged right and left, like facing pages, with the hinge mechanism 18 interposed therebetween. The long side 6a of the display housing 4 is arranged vertically.

FIG. 2 shows a second state of use in which the input unit 3 is in the second position and is open. In the second state of use, the user faces the display screen 6 and second keyboard 13 and can operate the second keyboard 13 while viewing the display screen 6. Further, in this state, the display screen 6 and second keyboard 13 are arranged in the depth direction, with the hinge mechanism 18 interposed therebetween. The long side 6a of the display housing 4 is arranged horizontally. Thus, the second keyboard 13 is positioned closer to the user than the display screen 6.

As shown in FIG. 4, a sensor 26 is incorporated in the bearing 25 of the keyboard housing 8. The sensor 26 detects, from the position of the ball 24, whether the input unit 3 is in the first or second position. The sensor 26 outputs a signal indicative of the position of the input unit 3. The display unit 2 and input unit 3 are controlled on the basis of this signal.

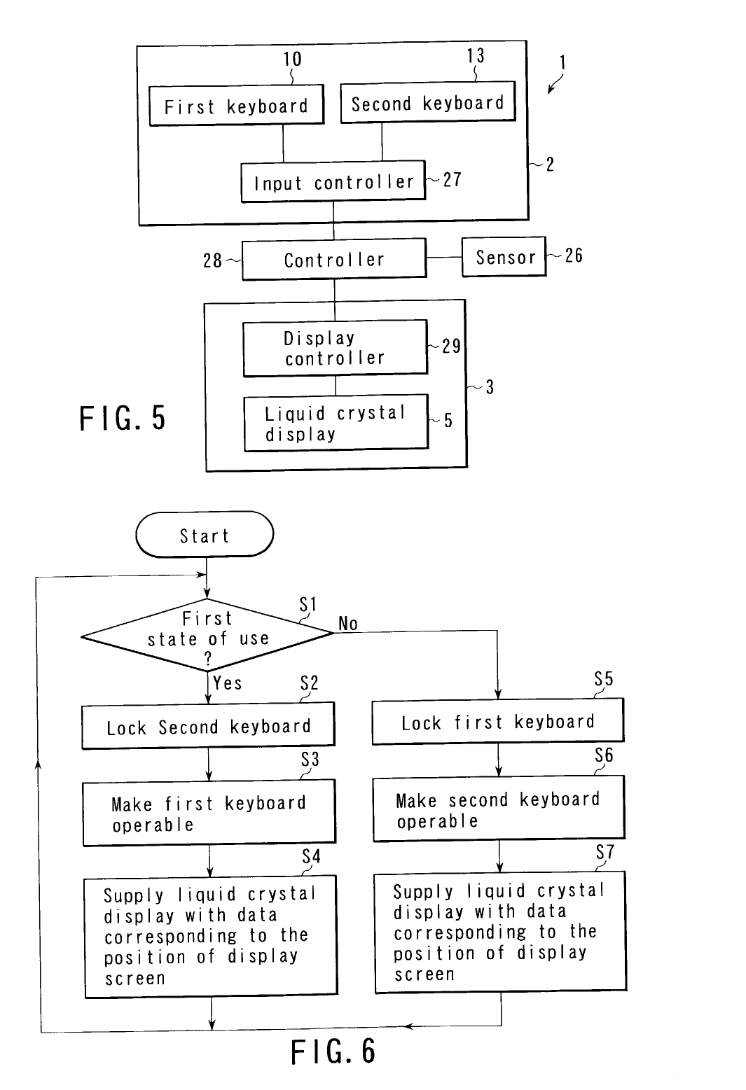

FIG. 5 shows the configurations of the display unit 2 and input unit 3. The input unit 3 has an input controller 27 for controlling the first and second keyboard 10 and 13 in accordance with the state of use of the PDA 1. Specifically, when the input unit 3 is in the first position, the input controller 27 electrically locks the second keyboard 13 (“lock” means to make the keyboard inoperable), and supplies a controller 28 with a character code input through the first keyboard 10. Further, when the input unit 3 is in the second position, the input controller 27 electrically locks the first keyboard 10, and supplies the controller 28 with a character code input through the second keyboard 13. The controller 28 controls the entire PDA 1. The signal output from the sensor 26 is input to the controller 28.

The way of locking of the first and second keyboards 10 and 13 is not limited to the aforementioned electrical locking. The keyboards 10 and 13 may be mechanically locked so that the keys 11 and 14 cannot be pushed, or a key switch (not shown) may be turned off.

The display unit 2 has a display controller 29 for controlling the liquid crystal display 5. The display controller 29 controls the display of the display screen 6 in accordance with the state of use of the PDA 1. Specifically, in the state of use in which the display screen 6 assumes the portrait position, the display controller 29 supplies the liquid crystal display 5 with the bit map data read from a VRAM (not shown), without converting the data. On the other hand, in the state of use in which the display screen 6 assumes the landscape position, the display controller 29 converts the bit map data read from the VRAM into data suitable for landscape display, and supplies the resultant data to the liquid crystal display 5.

The following table 1 shows an example of processing of (x, y) data on the bit map data executed by the display controller 29. In this example, the size of the display screen 6 is set to 240×320 dots (portrait size).

TABLE 1

| | First state | Second state |
|---|---|---|
| Original data | of use | of use |
| Bit map | Portrait size | Landscape size |
| (x, y) | (x, y) | (y, \|x-319\|) |
| (0, 0) | (0, 0) | (0, 319) |
| (1, 0) | (1, 0) | (0, 318) |
| . . . | . . . | . . . |
| (319, 0) | (319, 0) | (0, 0) |
| (0, 1) | (0, 1) | (1, 319) |

Referring then to the flowchart of FIG. 6, the process executed by the controller 28 will be described.

At a step S1, the controller 28 determines on the basis of a signal from the sensor 26 whether the PDA 1 is in the first or second state of use. If it is determined at the step S1 that the PDA 1 is in the first state of use, the program proceeds to a step S2, where the input controller 27 of the input unit 3 inputs, via the controller 28, information concerning the present state of use of the PDA 1. As a result, the input controller 27 locks the second keyboard 13, and makes the first keyboard 10 operable at the next step S3.

At a step S4, the display controller 29 of the display unit 2 inputs, via the controller 28, information concerning the present state of use of the PDA 1. As a result, the display controller 29 recognizes that the display screen 6 is in the portrait position, and then supplies the liquid crystal display 5 with the bit map data read from the VRAM, without converting the data.

If it is determined at the step S1 that the PDA 1 is not in the first state of use, the program proceeds to a step S5, where the input controller 27 of the input unit 3 inputs, via the controller 28, information concerning the present state of use of the PDA 1. As a result, the input controller 27 locks the first keyboard 10, and makes the second keyboard 13 operable at the next step S6.

At a step S7, the display controller 29 of the display unit 2 inputs, via the controller 28, information concerning the present state of use of the PDA 1. As a result, the display controller 29 recognizes that the display screen 6 is in the landscape position, thereby converting the bit map data read from the VRAM into data suitable for landscape display, and supplies the resultant data to the liquid crystal display 5.

In the above-described structure, to operate the PDA 1 by holding it in one hand, the display unit 2 is pivoted to the open position and the input unit 3 is rotated to the first position. In this state, the display screen 6 and first keyboard 10 are arranged right and left, like facing pages, and the display screen 6 is in the portrait position, i.e., in the first state of use. In this state, the user holds the PDA 1 in one hand, and operates the keyboard 10 by the other hand. The information input through the first keyboard 10 is displayed on the display screen 6.

In the first state of use, the second keyboard 13 of the input unit 3 is positioned opposite the first keyboard 10. Therefore, when the PDA 1 is held in one hand, the keys 14 of the second keyboard 13 may be touched accidentally. However, in the first state of use, the second keyboard 13 is locked by a signal from the sensor 26. Accordingly, even if the keys 14 of the second keyboard 13 are touched when the PDA 1 is held in one hand, erroneous information is prevented from being input.

On the other hand, to operate the PDA 1, placed on, for example, a desk, the input unit 3 is rotated through 180° from the first position to the second position. Further, the position of the PDA 1 is changed so that the input unit 3 is positioned closer to the user than the display unit 2. As a result, the display screen 6 and second keyboard 13 are arranged in the depth direction, assuming the second state of use, i.e., the landscape position. In this state, the user operates the second keyboard 13 using both hands. The information input through the second keyboard 13 is displayed on the display screen 6.

In the second state of use, the first keyboard 10 of the input unit 3 opposes the desk. Therefore, the keys 11 of the first keyboard 10 may be pushed against the desk when the second keyboard 13 is operated. However, in the second state of use, the first keyboard 10 is locked by a signal from the sensor 26. Accordingly, even if the keys 11 are pushed against the desk, erroneous information is prevented from being input.

As described above, in the PDA 1, the input unit 3 can be rotated within 180° relative to the display unit 2. This enables the user to select either the first keyboard 10 or the second keyboard 13 irrespective of whether the PDA 1 is operated held in one hand or placed on a desk. Thus, the PDA 1 is a very handy tool that has operability optimal for the state of use.

In particular, in the second state of use, the second keyboard 13 is in the landscape position, the keys 14 being provided on the entire second surface 8b of the keyboard housing 8. Accordingly, the keys 14 are larger than the keys 11 of the keyboard 10, and the pitch P2 of keys 14 is greater than that of keys 11, P1. This means that the size of the keys 14 and pitch P2 are sufficient for the user to operate the second keyboard 13 using both hands. Thus, the operability of the PDA 1 in the second state of use is enhanced, thereby reducing input errors.

In the first embodiment, the position of the input unit 3 is detected by the sensor 16, and one of the first and second keyboards 10 and 13 is locked on the basis of the detection result. However, the invention is not limited to this structure. The invention may be modified such that a selection key is incorporated in the input unit, and one of the first and second keyboards 10 and 13 is locked by operating the selection key.

Furthermore, the hinge mechanism 9 is not limited to the above-described structure.

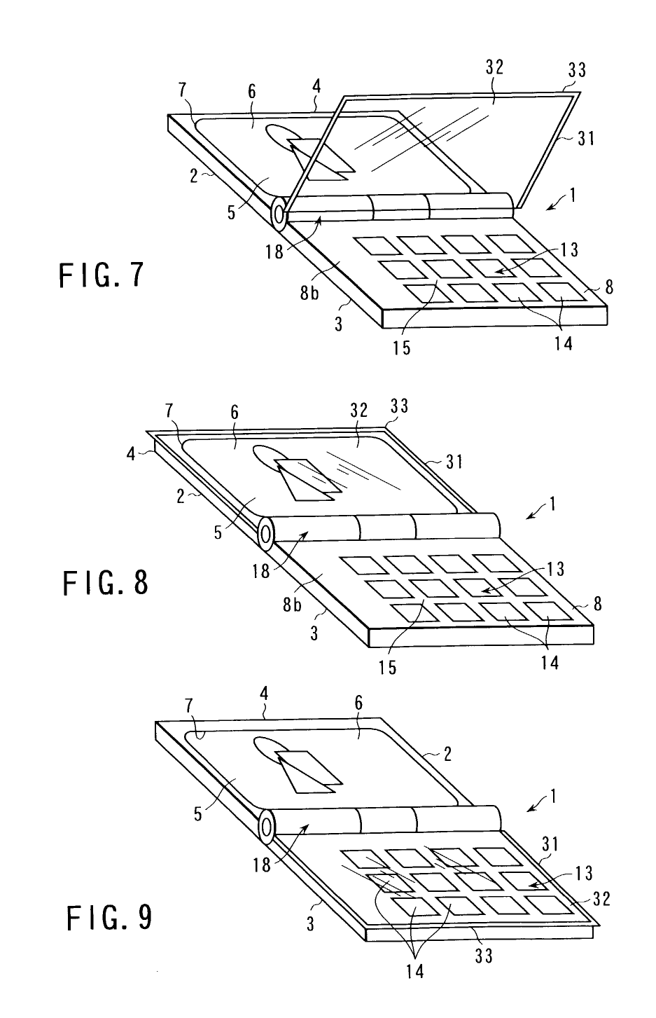

FIGS. 7-9 show a second embodiment of the invention.

In the second embodiment, a tablet 31 for an input operation using a pen is added to the PDA 1. The basic configuration of the PDA 1 of the second embodiment is similar to that of the first embodiment. Therefore, in the second embodiment, elements similar to those of the first embodiment are denoted by corresponding reference numerals, and no description is given thereof.

As seen from FIG. 7, the tablet 31 comprises a transparent touch sheet 32 having a plurality of transparent electrodes, and a frame 33 surrounding the sheet 32. The frame 33 of the tablet 31 is rotatably supported by a hinge mechanism 18. Thus, the tablet 31 is interposed between the display unit 2 and input unit 3, and is superposed upon the display screen 6 of the display unit 2 or the input unit 3.

FIG. 8 shows the tablet 31 superposed upon the display screen 6 in the second state of use in which the input unit 3 is in the second position. In this state, if a pen (not shown) pushes a desired portion of the touch sheet 32, corresponding information is displayed on the display screen 6. The information displayed on the display screen 6 can be seen through the transparent touch sheet 32.

FIG. 9 shows the tablet 31 superposed upon the second keyboard 13 of the input unit 3 in the second state of use. In this state, the keys 14 can be seen through the touch sheet 32, and can be operated using the tablet 31 as a touch pad.

In addition, in the first state of use in which the input unit 3 is in the first position, the tablet 31 can be superposed upon the first keyboard 10. Even in the first state of use where the display screen 6 is in the portrait position, the information input via the tablet 31 is displayed on the display screen 6.

The electronic apparatus of the invention is not limited to PDAs, but may also be a portable computer, another type of portable information tool, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a display unit having a display screen; and
an input unit which inputs information, the input unit including a first input operation section, and a second input operation section located opposite to the first input operation section, the second input operation section being larger than the first input operation section, the input unit being selectable between a first position in which the first input operation section can be operated while viewing the display screen, and a second position in which the second input operation section can be operated while viewing the display screen.

2. An electronic apparatus according to claim 1, wherein when the input unit is in the first position, the display screen is aligned with the first input operation section, and when the input unit is in the second position, the display screen is aligned with the second input operation section.

3. An electronic apparatus according to claim 1, wherein the input unit is pivotable between a closure position in which the input unit covers the display screen of the display unit, and an open position in which the display screen is exposed.

4. An electronic apparatus according to claim 3, further comprising a hinge mechanism connecting the display unit to the input unit, the hinge mechanism including first and second pivot sections, the first pivot section connecting the input unit to the display unit such that the input unit can pivot between the closure position and the open position, the second pivot section connecting the input unit to the display unit such that the input unit can rotate between the first position and the second position.

5. An electronic apparatus according to claim 1, wherein the input unit is reversible between the first position and the second position.

6. An electronic apparatus according to claim 1, wherein the first and second input operation sections each have a plurality of keys, the keys of the second input operation section being larger than the keys of the first input operation section.

7. An electronic apparatus according to claim 6, wherein the keys of the second input operation section are arranged with a pitch wider than a pitch with which the keys of the first input operation section are arranged.

8. An electronic apparatus according to claim 1, wherein the first and second input operation sections have equivalent input functions, and when information is input by operating any one of the first and second input operation sections, the input information is displayed on the display screen.

9. An electronic apparatus according to claim 1, further comprising lock means for making the second input operation section inoperable when the input unit is in the first position, and making the first input operation section inoperable when the input unit is in the second position.

10. An electronic apparatus according to claim 9, further comprising a sensor which detects whether the input unit is in the first position or the second position, and outputs a signal indicative of the detection result, and wherein the lock means operates in response to the signal from the sensor.

11. An electronic apparatus according to claim 4, wherein the hinge mechanism supports a tablet used to input information such that the tablet can pivot and be superposed upon any one of the display unit and the input unit.

12. An electronic apparatus comprising:
a display unit having a display screen;
an input unit which inputs information, the input unit including a first keyboard having a plurality of keys, and a second keyboard located opposite to the first keyboard and having a plurality of keys, the keys of the first keyboard being arranged in a different manner from arrangement of the keys of the second keyboard; and
a hinge mechanism connecting the display unit to the input unit, the hinge mechanism enabling the input unit to be selectively reversed between a first state of use in which the first keyboard can be operated while viewing the display screen, and a second state of use in which the second keyboard can be operated while viewing the display screen.

13. An electronic apparatus according to claim 12, wherein the keys of the second keyboard are larger than the keys of the first keyboard, and are arranged with a pitch wider than a pitch of the keys of the first keyboard.

14. An electronic apparatus according to claim 12, wherein the hinge mechanism has a hinge shaft interposed between the display unit and the input unit, the input unit being pivotable on the hinge shaft between a closure position in which the input unit covers the display screen of the display unit, and an open position in which the display screen is exposed.

15. An electronic apparatus according to claim 14, wherein the hinge shaft is positioned vertically in the first state of use, and positioned horizontally in the second state of use.

16. An electronic apparatus according to claim 15, wherein the display screen is rectangular, the display screen being aligned with the first keyboard in the first state of use, and the display screen being aligned with the second keyboard in the second state of use.

17. An electronic apparatus according to claim 15, wherein, in the first state of use, the display screen and the first keyboard are arranged right and left, with the hinge shaft interposed therebetween, and in the second state of use, the display screen and the second keyboard are arranged in a depth direction, with the hinge shaft interposed therebetween.

18. An electronic apparatus comprising:
a display unit having a display screen;
an input unit which inputs information, the input unit including a first input operation section, and a second input operation section located opposite to the first input operation section; and
a sensor which detects whether the input unit is in a first state of use in which the first input operation section can be operated while viewing the display screen, or in a second state of use in which the second input operation section can be operated while viewing the display screen.

19. An electronic apparatus according to claim 18, further comprising an input controller which locks the second input operation section to make it inoperable when the input unit is detected to be in the first state of use, the input controller locking the first input operation section to make it inoperable when the input unit is detected to be in the second state of use.

20. An electronic apparatus according to claim 18, further comprising a display controller which processes data, supplied to the display unit, in accordance with the position of the display screen, when the sensor has detected the state of use of the input unit.
